(19) United States
(12) Patent Application Publication
(10) Pub. No.: US 2011/0012875 A1
(43) Pub. Date: Jan. 20, 2011

(54) IMAGE DISPLAY DEVICE

(75) Inventors: Masahiro SAKAKIBARA, Toyokawa-shi (JP); Norimi YASUE, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/891,219

(22) Filed: Sep. 27, 2010

Related U.S. Application Data
(63) Continuation-in-part of application No. PCT/JP2009/055589, filed on Mar. 23, 2009.

(30) Foreign Application Priority Data
Mar. 31, 2008 (JP) 2008-094167

(51) Int. Cl. G06F 3/038

(52) U.S. Cl. 345/204

(57) ABSTRACT

An image display device includes: a light blocking part arranged outside an effective scanning range within a light scanning range of an optical scanning part and including opening regions through which a portion of light scanned at a position outside the effective scanning range passes and a mask region which blocks remaining light; and a radiation part which radiates the light which passes through the opening regions out of the light scanned by the optical scanning part at the position outside the effective scanning range to the outside of the image display device. Corresponding to a state of the image display device, the opening region through which the light passes is decided out of the plurality of opening regions. Light is radiated from the light source part when a scanning position of the optical scanning part is positioned at least in the opening region decided in this manner.

### CROSS-REFERENCE TO RELATED APPLICATIONS

The present application is a Continuation-in-Part of International Application PCT/JP2009/055589 filed on Mar. 23, 2009, which claims the benefits of Japanese Patent Application No. 2008-094167 filed on Mar. 31, 2008.

### BACKGROUND

1. Field

The present invention relates to an image display device, and more particularly to an optical scanning image display device which displays an image by scanning light radiated from a light source part two-dimensionally.

2. Description of the Related Art

Conventionally, there has been known an optical scanning image display device which displays an image by two-dimensionally scanning light generated based on an image signal.

This type of optical scanning image display device uses a laser which exhibits high directivity in monochromaticity as a light source part, light corresponding to an image signal is radiated from the light source part, and the light is scanned by an optical scanning part two-dimensionally. Then, the scanned light is projected on a projecting object thus displaying an image on the projecting object.

For example, as an optical scanning image display device, there has been known a retinal scanning display in which light scanned two-dimensionally is incident on a pupil of a viewer who is a user and a display of an image is performed by directly focusing an image on a retina. This retinal scanning display is, for example, configured to be used in such a manner that a user mounts the retinal scanning display on his head in the same manner as glasses. The retinal scanning display has an advantage that the retinal scanning display can provide a high-definition and large-viewing-angle image.

Further, as a scanning image display device, there has been known a laser projector which projects a two-dimensionally scanned light on a screen. This laser projector has, compared to a conventional projector which uses a metal halide lamp, an advantage that the laser projector is small and light-weighted and can obtain a projected image having favorable color reproducibility.

Here, to display an image using a laser beam or the like, the laser beam is required to possess intensity which exceeds a certain level. Accordingly, in conventional scanning image display devices, there has been proposed a scanning image display device which blocks the radiation of light from the device to enhance safety of a user.

In such a conventional scanning image display device, for example, in a state where scanning of laser beam is not normally performed, an optical scanning part is stopped and held at a predetermined position, and the laser beam from the optical scanning part held in such a place is blocked by a light blocking part thus preventing the radiation of the laser beam to the outside of the device.

### SUMMARY

The above-mentioned conventional scanning image display device can prevent the laser beam from being radiated from the device in the state where the scanning of laser beam is not normally performed. However, a user of the scanning image display device cannot grasp a scanning state of the laser beam including a case where the user cannot understand why the laser beam is not radiated from the scanning image display device.

Accordingly, it is an object of the present invention to provide an image display device which allows a user to grasp a state of the image display device such as a light scanning state of an optical scanning part.

According to one aspect of the present invention, there is provided an image display device which includes a light source part, an optical scanning part, a control part, a light blocking part and a radiation part. The light source part radiates light corresponding to intensity of an image signal. The optical scanning part scans the light radiated from the light source part two-dimensionally. The control part controls the light source part and the optical scanning part so as to allow the optical scanning part to scan the light radiated from the light source part within an effective scanning range thus displaying an image. The light blocking part is arranged at a position outside the effective scanning range within a light scanning range of the optical scanning part, and an opening region through which a portion of the light scanned at a position outside the effective scanning range passes and a mask region which blocks a remaining light are formed at the position outside the effective scanning range. The radiation part radiates, out of the light scanned by the optical scanning part at the position outside the effective scanning range, the light which passes through the opening region formed in the light blocking part to the outside of the device.

### BRIEF DESCRIPTION OF DRAWINGS

FIG. 1 is an explanatory view showing the constitution of an image display device according to a first embodiment;

FIG. 2 is a view for explaining a scanning mode of light by an optical scanning part of the image display device according to the first embodiment;

FIG. 3 is a view for explaining the arrangement of a light blocking part and a radiation part of the image display device according to the first embodiment;

FIG. 4 is a constitutional view of a light dividing part of the image display device according to the first embodiment;

FIG. 5 is a view showing the constitution of a light source part of the image display device according to the first embodiment;

FIG. 6 is an appearance view of the image display device according to the first embodiment;

FIG. 7 is a view for explaining a position of an opening region in the light blocking part of the image display device according to the first embodiment;

FIG. 8A is an explanatory view of a notification light visually observed in the image display device according to the first embodiment;

FIG. 8B is an explanatory view of the notification light visually observed in the image display device according to the first embodiment;

FIG. 8C is an explanatory view of the notification light visually observed in the image display device according to the first embodiment;

FIG. 9 is a view for explaining a radiation duration of light radiated from the light source part of the image display device according to the first embodiment;

FIG. 10 is a view showing the constitution of an image display device according to a second embodiment;

FIG. 11 is a view for explaining the arrangement of a light blocking part and a radiation part of the image display device according to the second embodiment;

FIG. 12 is a flowchart of notification processing in a control part of the image display device according to the second embodiment;

FIG. 13 is a view for explaining a position of an opening region in the light blocking part of the image display device according to the second embodiment;

FIG. 14A is an explanatory view of a notification light visually observed in the image display device according to the second embodiment;

FIG. 14B is an explanatory view of the notification light visually observed in the image display device according to the second embodiment; and

FIG. 14C is an explanatory view of the notification light visually observed in the image display device according to the second embodiment.

### DESCRIPTION

Hereinafter, preferred embodiments of the present invention are explained in conjunction with drawings. In the explanation made hereinafter, the explanation is made mainly with respect to a retinal scanning display which includes: a light source part which radiates light corresponding to an image signal; an optical scanning part which scans the light radiated from the light source part two-dimensionally; and a control part which controls the light source part and the optical scanning part. The retinal scanning display projects an image by directly projecting the light which is scanned by the optical scanning part on at least one retina of a user who is a viewer thus displaying the image. However, the present invention is not limited to the image display device. For example, the present invention is applicable to, besides such an image projection device which displays an image by projecting light scanned by an optical scanning part on a screen surface, other image display devices which display an image by scanning light.

### 1. First Embodiment

Hereinafter, the retinal scanning display 1 (hereinafter, referred to as “image display device 1”) of the first embodiment is explained in conjunction with drawings.

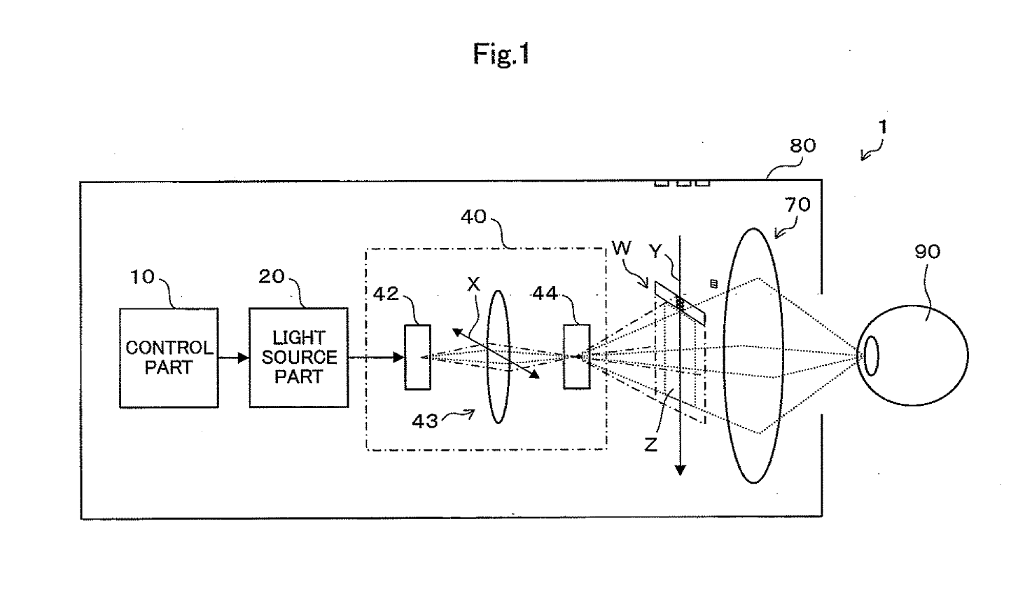

As shown in FIG. 1, the image display device 1 according to the first embodiment includes: a control part 10 which controls the whole image display device 1; a light source part 20 which radiates light corresponding to an image signal 1 in accordance with a control by the control part 10; an optical scanning part 40 which scans the light radiated from the light source part 20 two-dimensionally, and a relay optical system 70 which functions also as an eyepiece optical system. These parts are housed in a casing 80.

The optical scanning part 40 includes a horizontal scanning part 42 which functions as a high-speed scanning part for scanning light in the first scanning direction X (horizontal direction) at a relatively high speed, and a vertical scanning part 44 which functions as a low-speed scanning part for scanning the light which is scanned by the horizontal scanning part 42 and is incident on the vertical scanning part 44 via a relay optical system 43 in the second scanning direction Y (vertical direction) which is the direction intersecting with or arranged orthogonal to the first scanning direction X at a relatively low speed. The optical scanning part 40 scans the light radiated from the light source part 20 in the two-dimensional directions (two-dimensional scanning) thus forming an image for every frame. Here, the horizontal scanning part 42 includes a scanning element such as a galvanometer mirror, a horizontal scanning drive circuit for driving the scanning element and the like. The horizontal scanning part 42 is operated in response to control signals (horizontal synchronization signal, ON/OFF signal and the like) which are inputted to the horizontal scanning part 42 from the control part 10. Further, the vertical scanning part 44 includes a scanning element such as a galvanometer mirror, a vertical scanning drive circuit for driving the scanning element and the like. The vertical scanning part 44 is operated in response to control signals (vertical synchronization signal, ON/OFF signal and the like) which are inputted to the vertical scanning part 44 from the control part 10.

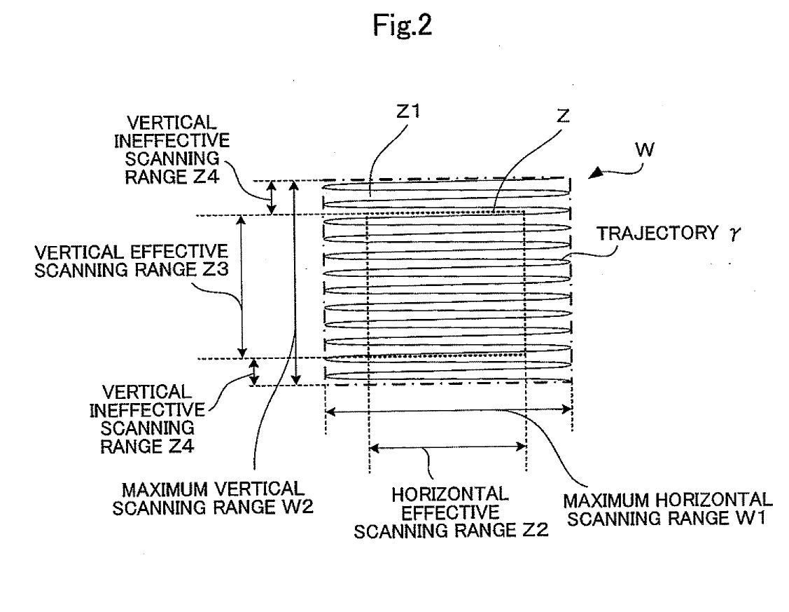

FIG. 1 and FIG. 2 show the relationship between a maximum scanning range W (a range defined by a maximum horizontal scanning range W1 and a maximum vertical scanning range W2 shown in FIG. 2) and an effective scanning range Z (a range defined by a horizontal effective scanning range Z2 and a vertical effective scanning range Z3 shown in FIG. 2) both of which are obtained by the horizontal scanning part 42 and the vertical scanning part 44. Here, the “maximum scanning range” implies a maximum range where light can be scanned by the horizontal scanning part 42 and the vertical scanning part 44.

The light whose intensity is modulated in response to an image signal S (hereinafter, referred to as “image forming light”) is radiated from the light source part 20 at timing where the scanning position of the horizontal scanning part 42 and the scanning position of the vertical scanning part 44 fall within the effective scanning range Z within the maximum scanning range W of the horizontal scanning part 42 and the vertical scanning part 44. Due to such processing, the image forming light is scanned within the effective scanning range Z by the horizontal scanning part 42 and the vertical scanning part 44, and the image forming light for 1 frame is scanned within the effective scanning range Z. This scanning is repeated for every image of 1 frame. In FIG. 2, a trajectory γ of the laser beam scanned by the horizontal scanning part 42 and the vertical scanning part 44 assuming that the laser beam is constantly radiated from the light source part 20 is virtually shown. However, the number of scanning lines in the first scanning direction X in the scanning performed by the horizontal scanning part 42 is several hundreds to several thousands for every 1 frame so that the trajectory γ of the laser beam is described in a simplified manner in FIG. 2. Further, in the explanation made hereinafter, a range Z1 within the maximum scanning range W formed by excluding the effective scanning range Z is referred to as “ineffective scanning range Z1”.

Then, the image forming light which is scanned by the optical scanning part 40 is directly projected on a retina of an eye 90 of a user who is a viewer via the relay optical system 70, and an image is projected on the retina. The user can visually recognize an image based on the image forming light scanned two-dimensionally in this manner.

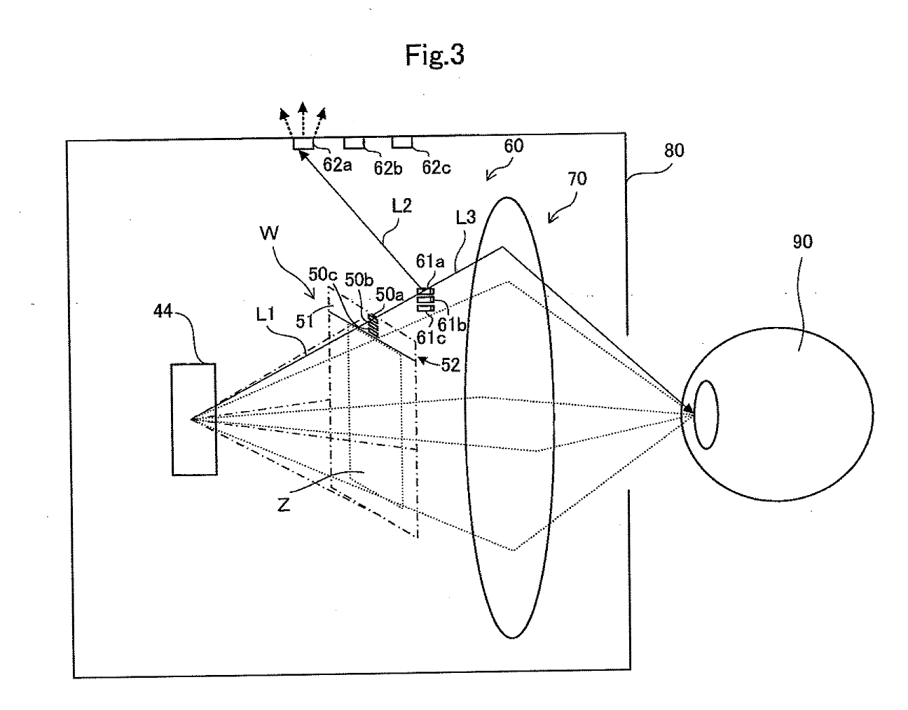

Further, the image display device 1 according to this embodiment includes, as shown in FIG. 3, a light blocking part 52 and a radiation part 60, and is configured to radiate a portion of light which is scanned at a predetermined position outside the effective scanning range Z to the outside of the casing 80 of the image display device (hereinafter referred to the outside of the device) via scattering plates 62a to 62c which constitute a radiation region.

That is, the light blocking part 52 is arranged at a predetermined position outside the effective scanning range Z within the maximum scanning range W of the optical scanning part 40. In the light blocking part 52, a plurality of opening regions 50a to 50c through which a portion of light which is scanned at the predetermined position outside the effective scanning range Z passes and a mask region 51 which blocks a remaining light are formed. Accordingly, although light which is scanned by the optical scanning part 40 toward the light blocking part 52 arranged at the predetermined position outside the effective scanning range Z is mostly blocked by the mask region 51, a portion of the light passes through the opening regions 50a to 50c.

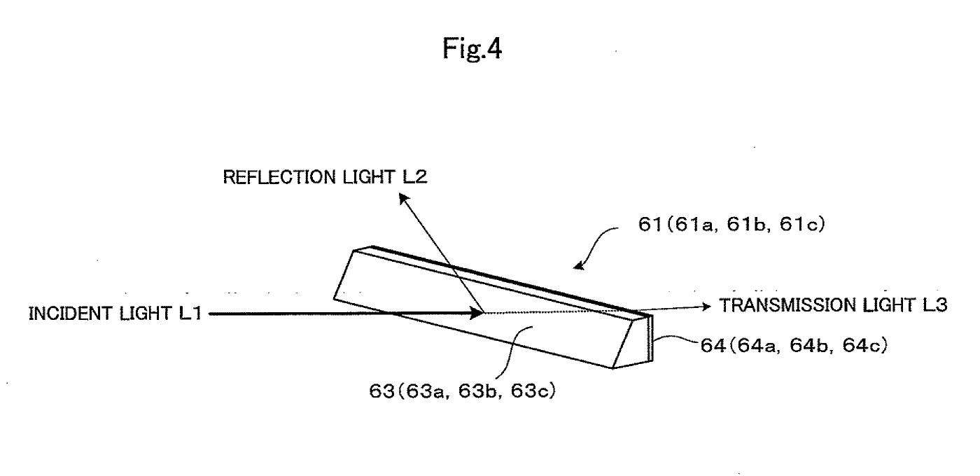

Further, the radiation part 60 includes light dividing parts 61a to 61c and transmissive scattering plates 62a to 62c. The light dividing parts 61a to 61c, as shown in FIG. 4, include half mirror surfaces 63a to 63c and filter surfaces 64a to 64c respectively. Light L2 which is a portion of light L1 which passes through the opening regions 50a to 50c is reflected on the half mirror surfaces 63a to 63c of the light dividing parts 61a to 61c and is radiated to the outside of the device from the scattering plates 62a to 62c. Further, light L3 which is a portion of the light L1 which passes through the opening regions 50a to 50c passes through the half mirror surfaces 63a to 63c of the light dividing parts 61a to 61c, and a light quantity is decreased by the filter surfaces 64a to 64c of the light dividing parts 61a to 61c. The radiation part 60 includes a portion of the relay optical system 70 which constitutes an eyepiece optical system for guiding the scanned light to an eye of a user who is a viewer via the relay optical system 70 and directly projects an image on a retina of the user, and the light L3 radiated from the filter surfaces 64a to 64c is incident on the eye 90 of the user who is a viewer via the relay optical system 70. By decreasing a light quantity of the light L3 by the filter surfaces 64a to 64c, it is possible to prevent the incidence of strong light L3 on the eye 90 of the user which is the viewer.

Then, the control part 10 notifies a user of a state of the image display device 1 using the light blocking part 52, the light dividing parts 61a to 61c, the scattering plates 62a to 62c and the relay optical system 70.

That is, the control part 10, at timing where the scanning position of the optical scanning part 40 is at the predetermined position outside the effective scanning range Z, allows light source part 20 to radiate the light for notification (hereinafter referred to as “notification light”) from the by controlling the light source part 20, the notification light is scanned by the optical scanning part 40, and the notification light is radiated to the outside of the device from the radiation part 60 thus enabling to notify the user and people other than the user of a state of the image display device 1.

Here, the notification light is radiated to the outside of the device from the radiation part 60 in the following three states as the state of the image display device 1.

(a) the image display device 1 being in an abnormal state;
(b) the image display device 1 being in a normal state; and
(c) the image display device 1 being in a standby state.

Further, the image display device 1 is configured to radiate lights of single monochromatic or composite colors of red (R), green (G), blue (B) from the light source part 20, and radiates the lights of different colors to the outside of the device via the radiation part 60 in the above-mentioned respective states (a) to (c).

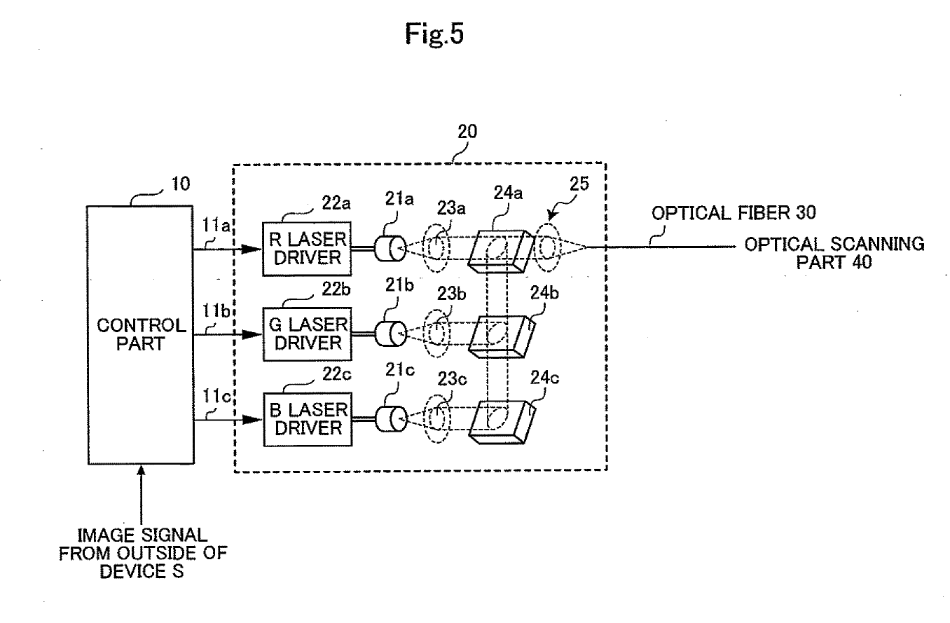

As shown in FIG. 5, the light source part 20 includes an R laser driver 22a, a G laser driver 22b and a B laser driver 22c for driving an R laser 21a, a G laser 21b and a B laser 21c respectively. Further, the light source part 20 includes collimation optical systems 23a to 23c which are provided for collimating laser beams radiated from the respective lasers 21a to 21c, dichroic mirrors 24a to 24c which synthesize collimated laser beams and an optical system 25 which guides the synthesized laser beams to an optical fiber 30. Here, a semiconductor laser such as a laser diode or a solid laser is used as the lasers 21a to 21c. Further, the control part 10 generates control signals 11a to 11c based on the image signal S from the outside of the device, a state of the image display device 1 and the like, and outputs the respective control signals 11a to 11c to the respective laser drivers 22a to 22c. Due to such a constitution, it is possible to radiate lights of single monochromatic or composite colors of red (R), green (G), blue (B) from the light source part 20.

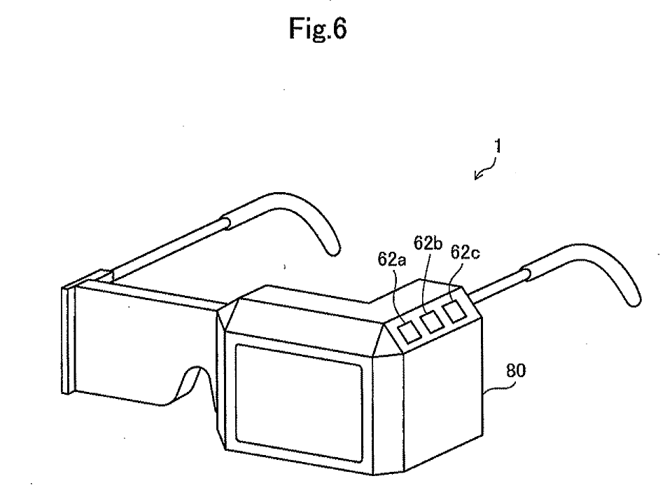

Further, as shown in FIG. 6, the image display device 1 is a head mounted display. A user can visually recognize an image while wearing the image display device 1 on his head. Further, as shown in FIG. 6, the scattering plates 62a to 62c are arranged in an exposed manner on portions of the casing 80 of the image display device 1 which are easily viewed from the outside of the image display device.

Firstly, the manner of operation when the image display device 1 is in an abnormal state is explained hereinafter.

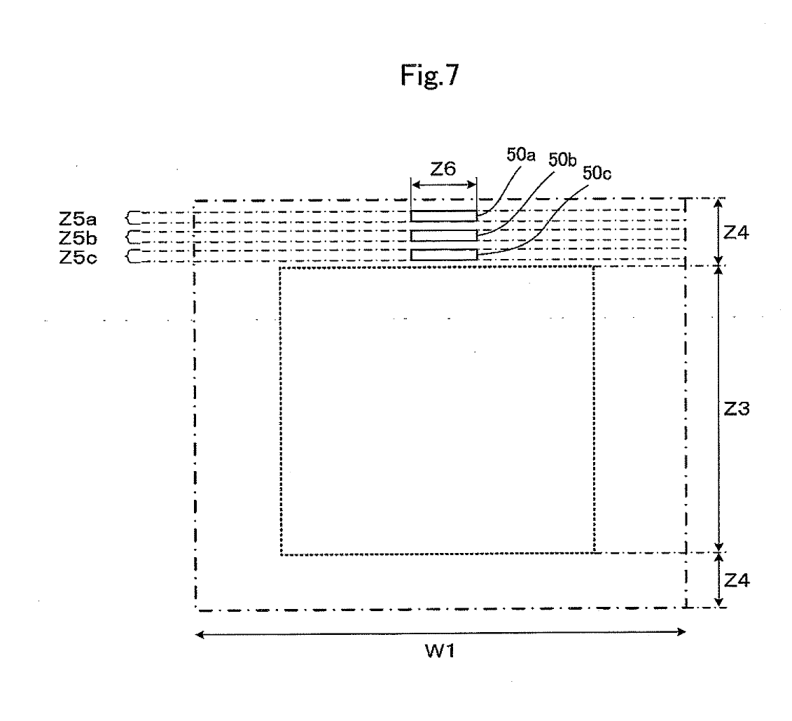

When the control part 10 determines that the image display device 1 is in an abnormal state, the control part 10 controls the vertical scanning part 44 so as to set a scanning position of the vertical scanning part 44 in the second scanning direction Y such that the scanning position assumes a position corresponding to an opening region 50a formed in a light blocking part (a position within a range Z5a shown in FIG. 7). Due to such an operation, light incident on the vertical scanning part 44 from the horizontal scanning part 42 via the relay optical system 43 is scanned in the second scanning direction Y by the vertical scanning part 44 within the range Z5a shown in FIG. 7.

Further, the control part 10 controls the light source part 20 such that a control signal 11a for notification is incident on the R laser driver 22a at timing where the scanning position assumes a position within the opening region 50a formed in the light blocking part 52 in the scanning range of the horizontal scanning part 42. Due to such an operation, red light (hereinafter referred to as “red notification light”) is radiated from the R laser 21a, is scanned by the optical scanning part 40, and passes through the opening region 50a. The red notification light which passes through the opening region 50a is partially reflected on a half mirror surface 63a of the light dividing part 61a, and the partially reflected light passes through a transmissive scattering plate 62a and is radiated to the outside of the casing 80. Further, the light which forms a portion of the red notification light which passes through the opening region 50a passes through the half mirror surface 63a of the light dividing part 61a, a quantity of the red notification light is decreased by the filter surface 64a, and the red notification light is incident on an eye 90 of a user from the filter surface 64a via the relay optical system 70.

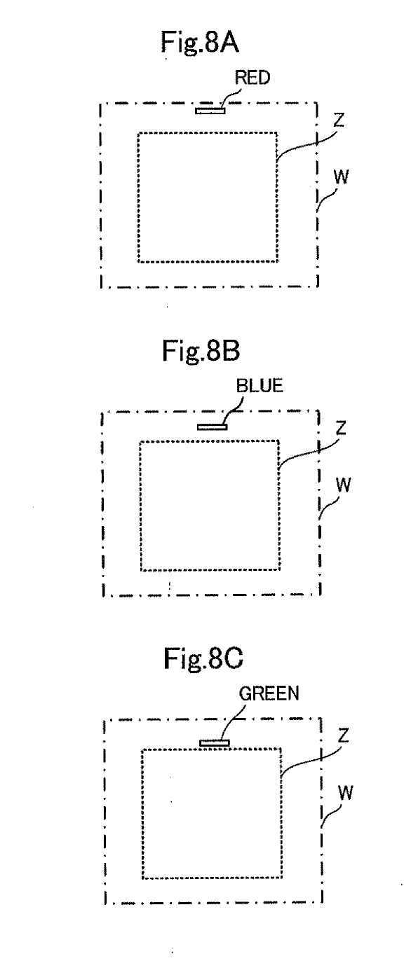

Accordingly, while wearing the image display device 1 on his head, as shown in FIG. 8A, the user of the image display device 1 can visually recognize the red notification light at a position outside the effective scanning range Z within a maximum scanning range W via the relay optical system 70 which functions as the radiation part 60. A person other than the user of the image display device 1 or the user who is not wearing the image display device 1 can visually recognize the state where the scattering plate 62a arranged on the casing 80 is colored in red.

In this manner, irrespective of whether or not the user is wearing the image display device 1 on his head, the user can visually recognize the red notification light so that the user can grasp a fact that the image display device 1 is in an abnormal state.

Here, the abnormal state implies various abnormal states including, for example, a state where the light source part 20 is abnormal, a state where the optical scanning part 40 is abnormal and the like. To cope with such a situation, in the image display device 1 according to this embodiment, a radiation duration of red notification light radiated from the R laser 21a is changed corresponding to kinds of abnormal states.

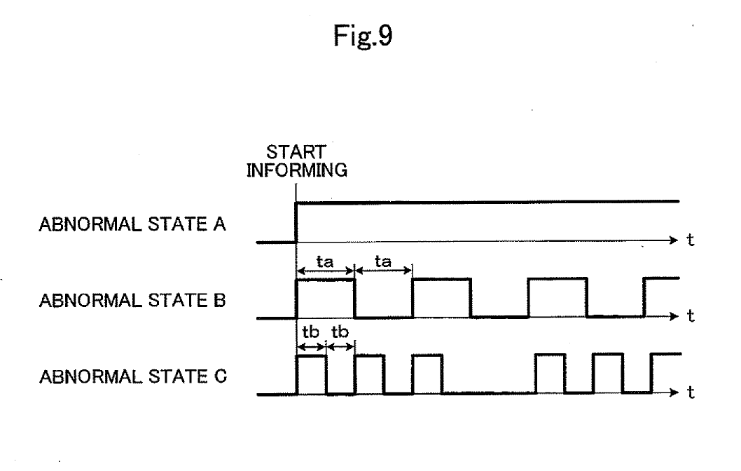

That is, kinds of abnormal states are classified into three states ranging from an abnormal state A to an abnormal state C, and the radiation duration of red notification light is changed as shown in FIG. 9. In the abnormal state A, the red notification light is continuously radiated from the R laser 21a. In the abnormal state B, the radiation of the red notification light and stopping of the radiation are repeated for every first period ta. In the abnormal state C, the radiation of the red notification light and stopping of the radiation are repeated for every second period tb.

Next, the manner of operation when the image display device 1 is in a normal state is explained. Here, the normal state implies a state where, when the scanning position of the optical scanning part 40 falls within the effective scanning range Z, the image forming light is radiated from the light source part 20 and the image forming light is scanned within the effective scanning range Z by the optical scanning part 40.

When the control part 10 determines that the image display device 1 is in a normal state, the control part 10 controls the vertical scanning part 44 so as to set a scanning position of the vertical scanning part 44 in the second scanning direction Y such that the scanning position assumes a position corresponding to an opening region 50b formed in the light blocking part (a position within a range Z5b shown in FIG. 7). Due to such an operation, light incident on the vertical scanning part 44 from the horizontal scanning part 42 via the relay optical system 43 is scanned in the second scanning direction Y by the vertical scanning part 44 within the range Z5b shown in FIG. 7.

Further, the control part 10 controls the light source part 20 such that a control signal 11c for notification is incident on the B laser driver 22c at timing where the scanning position assumes a position within the opening region 50b formed in the light blocking part 52 in the scanning range of the horizontal scanning part 42. Due to such an operation, blue light (hereinafter referred to as “blue notification light”) is radiated from the B laser 21c, is scanned by the optical scanning part 40, and passes through the opening region 50b. The blue notification light which passes through the opening region 50b is partially reflected on a half mirror surface 63b of the light dividing part 61b, and the partially reflected light passes through a transmissive scattering plate 62b and is radiated to the outside of the casing 80. Further, the light which forms a portion of the blue notification light which passes through the opening region 50b passes through the half mirror surface 63b of the light dividing part 61b, a quantity of the blue notification light is decreased by the filter surface 64b, and the blue notification light is incident on an eye 90 of a user from the filter surface 64b via the relay optical system.

Accordingly, while wearing the image display device 1 on his head, as shown in FIG. 8B, the user of the image display device 1 can visually recognize the blue notification light at a position outside the effective scanning range Z within a maximum scanning range W via the relay optical system 70 which functions as the radiation part 60. A person other than the user of the image display device 1 or the user who is not wearing the image display device 1 can visually recognize the state where the scattering plate 62b arranged on the casing 80 is colored in blue.

In this manner, irrespective of whether or not the user is wearing the image display device 1 on his head, the user can visually recognize the blue notification light so that the user can grasp a fact that the image display device 1 is in a normal state.

Next, the manner of operation when the image display device 1 is in a standby state is explained. Here, the standby state implies a state where the control part 10 waits for inputting of an image signal S or a state where an image is not displayed. That is, the standby state implies a state where although the scanning position of the optical scanning part 40 falls within the effective scanning range, an image forming light is not radiated from the light source part 20.

When the control part 10 determines that an image signal S is not inputted from the outside of the device and the image display device 1 is in a standby state, the control part 10 controls the vertical scanning part 44 so as to set a scanning position of the vertical scanning part 44 in the second scanning direction Y such that the scanning position assumes a position corresponding to an opening region 50c formed in the light blocking part (a position within a range Z5c shown in FIG. 7). Due to such an operation, light incident on the vertical scanning part 44 from the horizontal scanning part 42 via the relay optical system 43 is scanned in the second scanning direction Y by the vertical scanning part 44 within the range Z5c shown in FIG. 7.

Further, the control part 10 controls the light source part 20 such that a control signal 11b for notification is incident on the G laser driver 22b at timing where the scanning position assumes a position within the opening region 50c formed in the light blocking part 52 in the scanning range of the horizontal scanning part 42. Due to such an operation, green light (hereinafter referred to as “green notification light”) is radiated from the G laser 21b, is scanned by the optical scanning part 40, and passes through the opening region 50c. The green notification light which passes through the opening region 50c is partially reflected on a half mirror surface 63c of the light dividing part 61c, and the partially reflected light passes through a transmissive scattering plate 62c and is radiated to the outside of the casing 80. Further, the light which forms a portion of the green notification light which passes through the opening region 50c passes through the half mirror surface 63c of the light dividing part 61c, a quantity of the green notification light is decreased by the filter surface 64c, and the green notification light is incident on an eye 90 of a user from the filter surface 64c via the relay optical system 70.

Accordingly, while wearing the image display device 1 on his head, as shown in FIG. 8C, the user of the image display device 1 can visually recognize the green notification light at a position outside the effective scanning range Z within a maximum scanning range W via the relay optical system 70 which functions as the radiation part 60. A person other than the user of the image display device 1 or the user who is not wearing the image display device 1 can visually recognize the state where the scattering plate 62c arranged on the casing 80 is colored in green.

In this manner, irrespective of whether or not the user is wearing the image display device 1 on his head, the user can visually recognize the green notification light so that the user can grasp a fact that the image display device 1 is in a standby state. Further, since the scanning by the horizontal scanning part 42 is performed at a high speed, it takes time until a scanning operation by a scanning element (not shown in the drawing) of the horizontal scanning part 42 becomes stable. However, notification processing in horizontal scanning is performed by the horizontal scanning part 42 in a standby state and hence, an image display operation can be performed rapidly.

As has been described above, the control part 10 of the image display device 1 according to this embodiment decides the opening region which allows the light to pass therethrough out of the plurality of opening regions 50a to 50c corresponding to the information to be notified to the user who is the viewer, and radiates the notification light from the light source part 20 when the scanning position of the optical scanning part 40 is at least at the position of the opening region decided in this manner. Accordingly, the user can grasp the state (abnormal state, normal state, standby state or the like) of the image display device 1 based on the opening region through which the notification light is radiated. Further, the state of the image display device 1 can be also grasped by confirming that the notification light is not radiated through the opening regions 50a to 50c. For example, when the notification light is not radiated through the opening regions 50a to 50c although the image display device 1 is normally manipulated, it is understood that the light source part 20 is in defect or the like.

The control part 10 sets the light radiated from the light source part 20 at the positions of the opening regions 50a to 50c formed in the light blocking part 52 within the scanning range of the optical scanning part 40 to light of color corresponding to the information to be notified to the user and hence, the user can also grasp the state of the image display device 1 based on the color of the light.

Further, the control part 10 changes the duration of the control for allowing the light source part 20 to radiate the light at the positions of the opening regions 50a to 50c formed in the light blocking part 52 within the scanning range of the optical scanning part 40 corresponding to the information to be notified to the user (FIG. 9) and hence, the user can grasp the state of the image display device 1 based on the duration of light.

Further, by arranging the opening regions 50a to 50c at the center in the first scanning direction X in symmetry and in an offset manner in the second scanning direction Y, even when the high-speed scanning element of the horizontal scanning part 42 suffers from a defect, the notification light can pass through the opening regions 50a to 50c. That is, when the scanning element of the horizontal scanning part 42 suffers from a defect, usually, the scanning position stops in the vicinity of the center in the first scanning direction X. Accordingly, the opening regions 50a to 50c are arranged to be present in the vicinity of the center in the first scanning direction X.

In the above-mentioned embodiment, the scanning position of the vertical scanning part 44 in the second scanning direction Y is set to the ranges Z5a to Z5c shown in FIG. 7 corresponding to the state of the image display device 1. However, the light scanned by the vertical scanning part 44 may be fixed at the respective center positions of the ranges Z5a to Z5c shown in FIG. 7.

Further, in the above-mentioned embodiment, the notification light is radiated from the plurality of radiation regions (scattering plates 62a to 62c) while changing the color and the position of the notification light corresponding to the state of the image display device 1. However, the light blocking part 52 and the radiation part 60 may be configured such that the light blocking part 52 includes only one opening region and the radiation part 60 includes only one radiation region, and the notification light is radiated from one radiation region by changing the colors and the radiation durations (lighting pattern) of the notification light.

In the above-mentioned embodiment, the opening regions 50a to 50c are arranged at the center in the first scanning direction X in symmetry and in an offset manner in the second scanning direction Y. However, the opening regions 50a to 50c may be arranged in an offset manner in the first scanning direction X at a position in the substantially equal second scanning direction Y.

In the above-mentioned embodiment, the light blocking part 52 is arranged in the ineffective scanning range Z1 above the effective scanning range Z. However, the light blocking part 52 may be arranged in the ineffective scanning range Z1 below the effective scanning range Z.

### 2. Second Embodiment

Next, an image display device 1′ according to the second embodiment is explained in conjunction with drawings. Since a radiation part, an optical scanning part and a relay optical system are substantially equal to the corresponding parts of the image display device according to the first embodiment, the explanation of these parts is made by adding the same symbols.

In the above-mentioned image display device 1 according to the first embodiment, the light blocking part is arranged in the ineffective scanning range Z1 above the effective scanning range Z. However, in the image display device 1′ according to the second embodiment, the light blocking part is arranged in the ineffective scanning range Z1 above the effective scanning range Z and in the ineffective scanning range Z1 below the effective scanning range Z respectively.

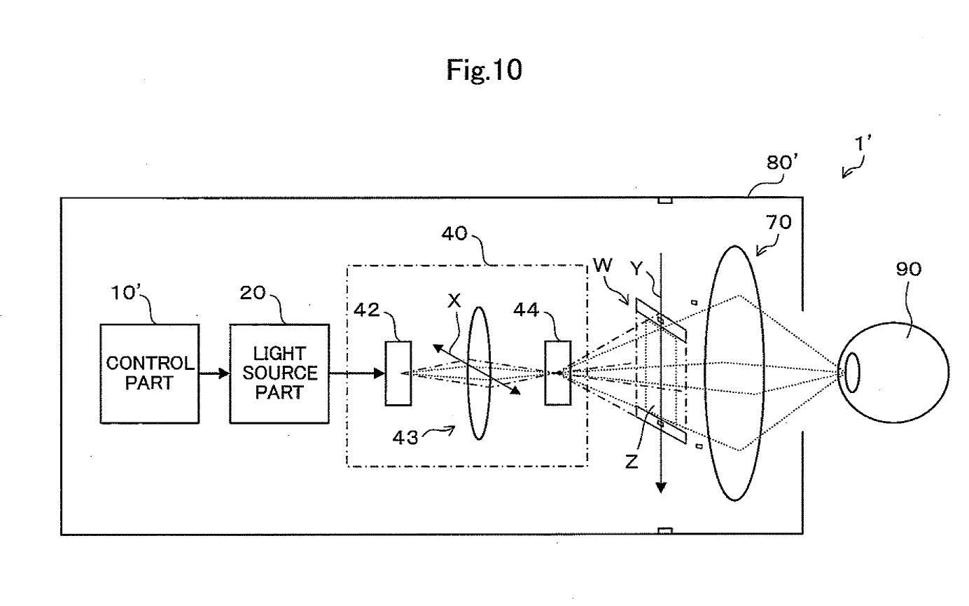

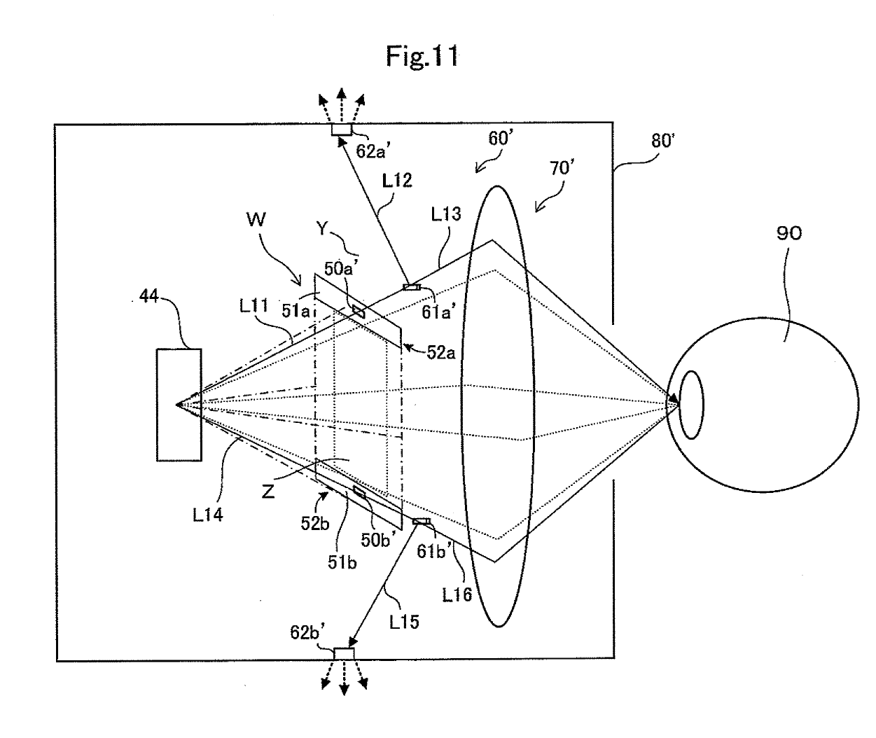

That is, as shown in FIG. 10 and FIG. 11, a first light blocking part 52a is arranged in the ineffective scanning range Z1 above the effective scanning range Z, and a second light blocking part 52b is arranged in the ineffective scanning range Z1 below the effective scanning range Z. On the respective light blocking parts 52a, 52b, at a predetermined position outside the effective scanning range Z within a scanning range of an optical scanning part 40, a plurality of opening regions 50a′, 50b′ which allow a portion of light scanned at a predetermined position outside the effective scanning range Z to pass therethrough and a mask region 51a, 51b which blocks remaining light are formed respectively.

Further, a radiation part includes a first radiation part 60a and a second radiation part 60b. The first radiation part 60a is constituted of a light dividing part 61a′ and a transmissive scattering plate 62a′, while the second radiation part 60b is constituted of a light dividing part 61b′ and a transmissive scattering plate 62b′. The light dividing part 61a′, 61b′ has the same constitution as the light dividing part 61 of the first embodiment (see FIG. 4), and includes a half mirror surface and a filter surface. Further, the first radiation part 60a and the second radiation part 60b include a portion of a relay optical system 70 respectively. The scattering plates 62a′, 62b′ are mounted on a casing 80′ of the image display device 1′ in an exposed manner.

As shown in FIG. 11, light L12 which forms a portion of light L11 which passes through the opening region 50a′ is reflected on the half mirror surface of the light dividing part 61a′ and is radiated to the outside of the device from the scattering plate 62a′. On the other hand, light L13 which forms a portion of the light L11 which passes through the opening region 50a′ passes through the half mirror surface of the light dividing part 61a′, a light quantity of the light L13 is decreased by the filter surface, and the light L13 is incident on an eye 90 of a user from the filter surface via the relay optical system 70. In the same manner, light L15 which forms a portion of light L14 which passes through the opening region 50b′ is reflected on the half mirror surface of the light dividing part 61b′ and is radiated to the outside of the device from the scattering plate 62b′. On the other hand, light L16 which forms a portion of the light L14 which passes through the opening region 50b′ passes through the half mirror surface of the light dividing part 61b′, a light quantity of the light L16 is decreased by the filter surface, and the light L16 is incident on the eye 90 of the user from the filter surface via the relay optical system 70.

Next, notification processing executed in the image display device 1′ is explained. This notification processing is executed by the control part 10′ when the image display device 1′ is started with the supply of a power source and every predetermined period after the image display device 1′ is started.

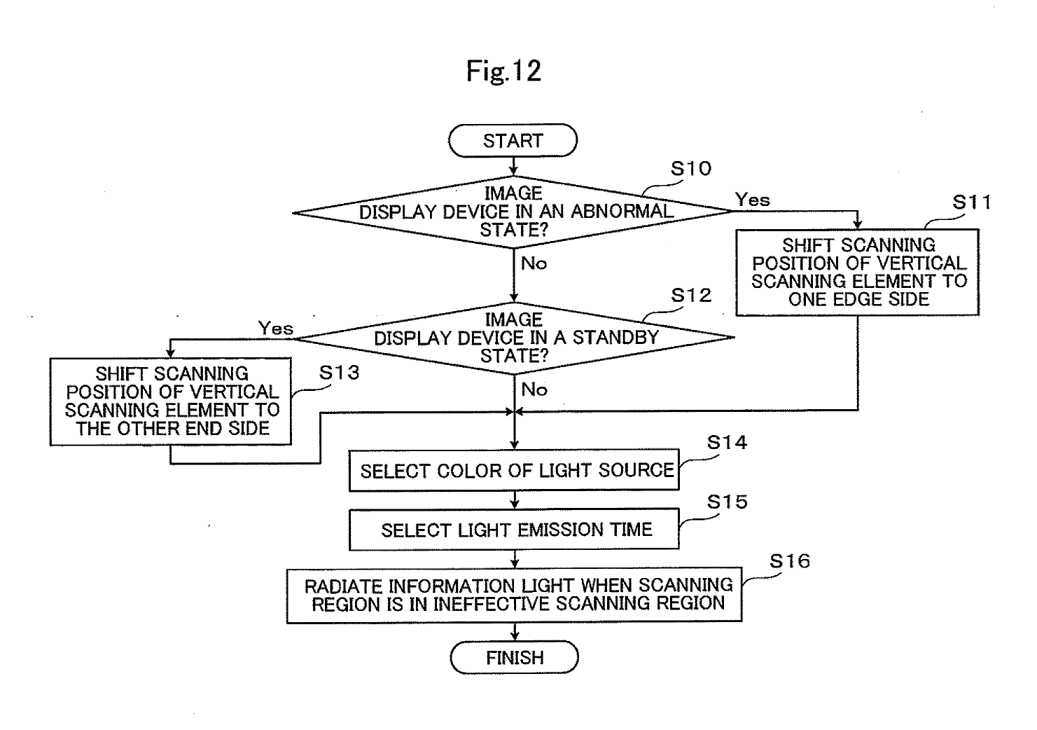

As shown in FIG. 12, when the notification processing starts, the control part 10′ determines whether or not the image display device 1′ is in an abnormal state (step S10).

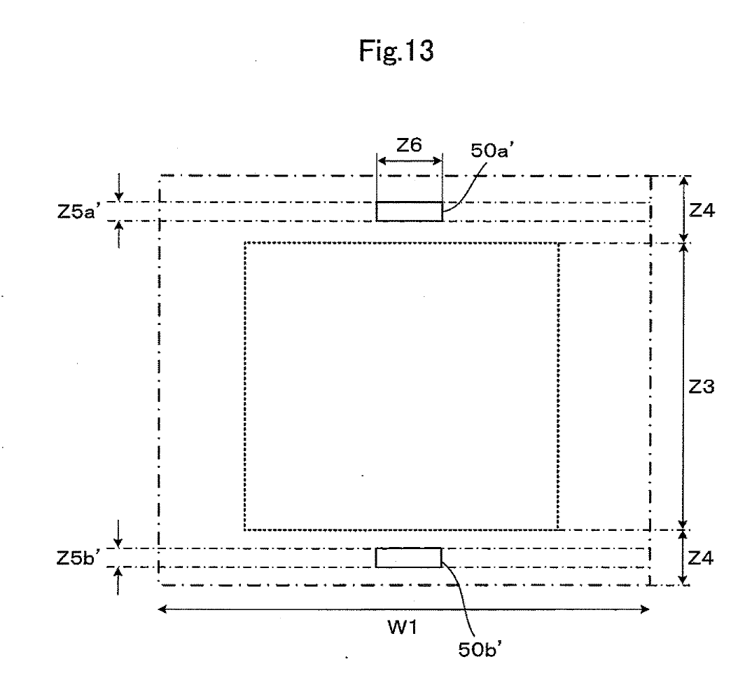

In this processing, when the control part 10′ determines that the image display device 1′ is in an abnormal state (step S10: Yes), the control part 10′ shifts a scanning position of a scanning element not shown in the drawing of a vertical scanning part 44 (hereinafter referred to as “vertical scanning element”) to one edge side (step S11). That is, when the control part 10′ determines that the image display device 1′ is in an abnormal state, the control part 10′ controls the vertical scanning part 44 so as to set the scanning position of the vertical scanning element of the vertical scanning part 44 in the second scanning direction Y such that the scanning position assumes a position corresponding to the opening region 50a′ formed in the light blocking part (the position within the range Z5a′ shown in FIG. 13). Due to such an operation, light incident on the vertical scanning part 44 from the horizontal scanning part 42 via the relay optical system 43 is ready for being scanned by the vertical scanning part 44 in the second scanning direction Y within a range Z5a′ shown in FIG. 13.

On the other hand, in step S10, when the control part 10′ determines that the image display device 1′ is not in an abnormal state (step S10: No), the control part 10′ determines whether or not the image display device 1′ is in a standby state (step S12). The standby state implies a state where the control part 10′ waits for inputting of an image signal S or a state where an image is not displayed. That is, the standby state implies a state where although the scanning position of the optical scanning part 40 falls within the effective scanning range Z, image forming light is not radiated from the light source part 20.

In this processing, when the control part 10′ determines that the image display device 1′ is in a standby state (step S12: Yes), the control part 10′ shifts the scanning position of the vertical scanning element of the vertical scanning part 44 to the other end side (step S13). That is, when the control part 10′ determines that the image display device 1′ is in a standby state, the control part 10′ controls the vertical scanning part 44 so as to set the scanning position of the vertical scanning element of the vertical scanning part 44 in the second scanning direction Y such that the scanning position assumes a position corresponding to the opening region 50b′ formed in the light blocking part (the position within the range Z5b′ shown in FIG. 13). Due to such an operation, light incident on the vertical scanning part 44 from the horizontal scanning part 42 via the relay optical system 43 is ready for being scanned by the vertical scanning part 44 in the second scanning direction Y within a range Z5b′ shown in FIG. 13.

When the processing in step S11 and step S13 is finished or when the control part 10′ determines that the image display device 1′ is not in a standby state in step S12 (step S12: No), the control part 10′ selects color of light source (step S14). Here, red is selected when the image display device 1′ is in an abnormal state, green is selected when the image display device 1′ is in a standby state, and blue is selected when the image display device 1′ is in a normal state which differs from an abnormal state and a standby state.

Next, the control part 10′ selects a light emission time (radiation duration) (step S15). Here, selected is a mode where light flickers when the image display device 1′ is in an abnormal state, and a mode where light is always lit when the image display device 1′ is in a standby state and in a normal state.

Finally, when the scanning region of the optical scanning part 40 falls within the ineffective scanning region, the control part 10′ starts the radiation of notification light from the light source part 20 with color and light emission time selected in steps S14, S15 (step S16), and finishes the processing.

When the image display device 1′ is in an abnormal state, the control part 10′ controls the light source part 20 such that a control signal 11a for notification is continuously incident on an R laser driver 22a. Due to such an operation, red notification light is continuously radiated from the R laser 21a, and a portion of the red notification light passes through the opening region 50a′, is radiated to the outside of a casing 80′ from the scattering plate 62a′ via the light dividing part 61a′, and is incident on an eye 90 of a user via the relay optical system 70. Although the red notification light is continuously radiated from the R laser 21a, the red notification light is blocked by a mask region 51a′ at scanning positions other than the opening region 50a′ formed in the light blocking part 52a′ and hence, the red notification light is not incident on the eye 90 of the user.

Further, when the image display device 1′ is in a standby state, the control part 10′ performs a further control of the light source part 20 such that a control signal 11b for notification is continuously incident on a G laser driver 21b. Due to such an operation, green notification light is continuously radiated from the G laser 21b, and a portion of the green notification light passes through the opening region 50b′, is radiated to the outside of the casing 80′ from the scattering plate 62b′ via the light dividing part 61b′, and is incident on the eye 90 of the user via the relay optical system 70. Although the green notification light is continuously radiated from the G laser 21b, the green notification light is blocked by a mask region 51b′ at scanning positions other than the opening region 50b′ formed in the light blocking part 52b′ and hence, the green notification light is not incident on the eye 90 of the user.

Further, when the image display device 1′ is in a normal state, in addition to the radiation processing in which the image forming light is radiated from the light source part 20 and the scanning processing by the optical scanning part 40 within the effective scanning range Z, the control part 10′ further performs a control of the light source part 20 so as to input the control signal 11b for notification to the B laser driver 22c at timing where at least the scanning position of the optical scanning part 40 assumes a position in the opening region 50b′ formed in the light blocking part 52b′. Due to such an operation, the blue notification light is radiated from the B laser 21c, passes through the opening region 50b′, is radiated to the outside of the casing 80′ from the scattering plate 62b′ via the optical dividing part 61b′, and is incident of the eye 90 of the user via the relay optical system 70.

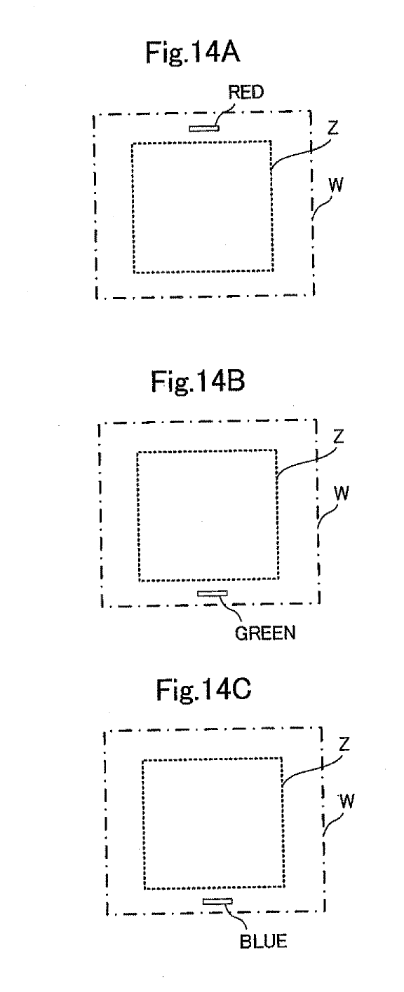

Accordingly, while wearing the image display device 1 on his head, as shown in FIG. 14A to FIG. 14C, the user of the image display device 1′ can visually recognize the notification light at a position outside the effective scanning range Z via the relay optical system 70. A person other than the user of the image display device 1′ or the user who is not wearing the image display device 1′ also can visually recognize the state where the scattering plate 62a′, 62b′ arranged on the casing 80′ is colored in red, green or blue.

In the above-mentioned second embodiment, one opening region is formed in the light blocking parts 52a, 52b respectively. However, a plurality of opening regions may be formed in the light blocking parts 52a, 52b respectively.

Although some embodiments of the present invention have been explained in detail in conjunction with drawings heretofore, they are merely described as examples, and the present invention can be carried out in other modes with various modifications and improvements by those who are skilled in the art.

For example, in the above-mentioned embodiments, the light blocking part 52 is arranged above or below the effective scanning range Z within the ineffective scanning range Z1. However, light blocking part 52 may be arranged in the ineffective scanning range Z1 on left or right sides (X direction) of the effective scanning range Z.

In the above-mentioned embodiments, the radiation part 60′ is configured to radiate the notification light via the scattering plates 62a′ 62b′ and the relay optical system 70. However, the notification light may be radiated only via the relay optical system 70 or may be radiated only via the scattering plate.

In the above-mentioned embodiments, the explanation has been made with respect to the radiation part 60′ which is configured to radiate the notification light to the outside of the device via the scattering plate. However, provided that the notification light can be radiated to the outside of the device in a diffused manner, the radiation part is not limited to the above-mentioned constitution.

Further, a light detection part for detecting light which passes through the opening region formed in the light blocking part may be provided, and an operation of the light source part 20 may be stopped when the light detection part does not detect light although the control part performs a control so as to allow light to pass through the opening region.

Further, a manipulation part which can be manipulated by the user may be provided, and the relationship between the state of the image display device and color, radiation duration and an opening region for inspection light may be set. Due to such a constitution, the image display device can perform notification processing based on notification light which conforms to liking of a user.

What is claimed is:

1. An image display device comprising:
a light source part which is configure to radiate light corresponding to intensity of an image signal;
an optical scanning part which is configured to scan the light radiated from the light source part two-dimensionally;
a control part which is configured to control the light source part and the optical scanning part so as to allow the optical scanning part to scan the light radiated from the light source part within an effective scanning range thus displaying an image;
a light blocking part which is arranged at a position outside the effective scanning range within a light scanning range of the optical scanning part, and includes an opening region through which a portion of light scanned at a position outside the effective scanning range passes and a mask region which is configured to block remaining light; and
a radiation part which is configured to radiate the light which passes through the opening region formed in the light blocking part out of the light scanned by the optical scanning part at the position outside the effective scanning range to the outside of the image display device.

2. The image display device according to claim 1, wherein the plurality of opening regions are formed in the light blocking part,
the radiation part includes a plurality of radiation regions which are configured to radiate lights which pass through the respective opening regions to the outside of the image display device, and
the control part is configured to decide the opening region through which the light is allowed to pass out of the plurality of opening regions corresponding to information to be notified to a user, and is configured to allow the light source part to radiate light when a scanning position of the optical scanning part is positioned in the decided opening region.

3. The image display device according to claim 1, wherein the light source part is configured to radiate lights of different colors,
the control part is configured to set the light radiated from the light source part at a position of the opening region formed in the light blocking part within the scanning range of the optical scanning part to light of color corresponding to information to be notified to the user.

4. The image display device according to claim 1, wherein the control part is configured to change a duration of a control for allowing the light source part to radiate the light at a position of the opening region formed in the light blocking part within the scanning range of the optical scanning part corresponding to information to be notified to the user.

5. The image display device according to claim 1, wherein the control part is configured to, when the control part determines that the image display device is in a normal state, perform a control which allows the light source part to radiate light at a position of the opening region of the light blocking part within a scanning range of the optical scanning part.

6. The image display device according to claim 1, wherein the optical scanning part includes a high-speed scanning part which scans light at a relatively high speed in a first scanning direction and a low-speed scanning part which scans light at a relatively low speed in a second scanning direction which is a direction intersecting with or arranged orthogonal to the first scanning direction, and
the control part is configured, when the control part determines that the image display device is in an abnormal state, to set a scanning position of the low-speed scanning part in the second scanning direction so as to assume a position corresponding to the opening region formed in the light blocking part, and to perform a control which allows the light source part to radiate light at a position of the opening region formed in the light blocking part within the scanning range of the high-speed scanning part.

7. The image display device according to claim 1, wherein the optical scanning part includes a high-speed scanning part which scans light at a relatively high speed in a first scanning direction and a low-speed scanning part which scans light at a relatively low speed in a second scanning direction which is a direction intersecting with or arranged orthogonal to the first scanning direction, and
the control part is configured, when the control part determines that the image display device is in a standby state where the image is not displayed, to set a scanning position of the low-speed scanning part in the second scanning direction so as to assume a position corresponding to the opening region formed in the light blocking part, and to perform a control which allows the light source part to radiate light at a position of the opening region formed in the light blocking part within the scanning range of the high-speed scanning part.

8. The image display device according to claim 1, wherein the optical scanning part includes a high-speed scanning part which scans light at a relatively high speed in a first scanning direction and a low-speed scanning part which scans light at a relatively low speed in a second scanning direction which is a direction intersecting with or arranged orthogonal to the first scanning direction, and
the light blocking part is constituted of a first light blocking part and a second light blocking part which are arranged in a spaced-apart manner from each other in the second scanning direction with the effective scanning region sandwiched therebetween, and each light blocking part includes the opening region and the mask region.

9. The image display device according to claim 8, wherein the control part determines whether or not the image display device is in an abnormal state, and the control part performs a control which allows the light source part to radiate light at a position of the opening region formed in the first light blocking part within the scanning range of the optical scanning part when the control part determines that the image display device is in an abnormal state, and a control which allows the light source part to radiate light at a position of the opening region formed in the second light blocking part within the scanning range of the optical scanning part when the control part determines that the image display device is not in an abnormal state.

10. The image display device according to claim 1, wherein the radiation part includes an eyepiece optical system which guides light scanned by the optical scanning part to an eye of a user outside the image display device and directly projects an image on a retina of the user, and is configured to guide the light which passes through the opening region formed in the light blocking part to the eye of the user via the eyepiece optical system.

11. The image display device according to claim 10, wherein the radiation part includes a filter which reduces a light quantity of light which passes therethrough.

12. The image display device according to claim 10, wherein the radiation part is configured to guide the light which passes through the opening region formed in the light blocking part to a position outside the image display device such that a person other than the user can visually recognize the light in addition to the eye of the user.
